(19) United States
(12) Patent Application Publication
(10) Pub. No.: US 2011/0027566 A1
(43) Pub. Date: Feb. 3, 2011

(54) NATURAL-STONE COMPOSITE PANEL AND METHOD OF MAKING THE SAME

(75) Inventors: Seok Bong Lee, Chungcheongbuk-do (KR); Jong Seok Son, Chungcheongbuk-do (KR)

Correspondence Address: KNOBBE MARTENS OLSON & BEAR LLP, 2040 MAIN STREET, FOURTEENTH FLOOR, IRVINE, CA, 92614, US

(73) Assignee: LG HAUSYS, LTD., SEOUL (KR)

(21) Appl. No.: 12/934,960

(22) PCT Filed: Mar. 27, 2009
(86) PCT No.: PCT/KR09/01584

§ 371 Date: Sep. 27, 2010

(30) Foreign Application Priority Data
Mar. 28, 2008 (KR) 10-2008-0029242
May 13, 2008 (KR) 10-2008-0044063

(51) Int. Cl. B32B 9/00; B31B 1/62; B32B 3/00; D04H 13/00; B32B 21/04; D03D 9/00; D03D 15/00

(52) U.S. Cl. 428/220; 156/60; 428/292.1; 428/537.1; 428/688; 442/1; 442/181; 442/327

(57) ABSTRACT

The present disclosure relates to a natural stone composite panel including natural stone and a composite reinforcing layer or layers which is (are) formed on one or both surfaces of the natural stone sheet and which has (have) one or more strengthening layer(s) and one or more base-material layer(s). The present disclosure also relates to a production method therefor. In the present disclosure, natural stone is reinforced by means of the composite reinforcing layer (or layers) comprising the strengthening layer(s) and base-material layer(s), and outstanding strength can be achieved even when the natural stone portion of the panel is extremely thin. Consequently, the present disclosure provides a composite panel of natural stone having outstanding properties such as low weight, ease of handling, efficiency of construction and low cost, while maintaining outstanding resistance to shock.

### TECHNICAL FIELD

The present invention relates to a natural stone composite panel that has outstanding properties, such as light weight, easy handling, construction efficiency and economic feasibility, while exhibiting outstanding strength even with a very low thickness of natural stone in the panel. The present disclosure also relates to a method of fabricating the same.

### BACKGROUND

Recently, a variety of materials using, for example, natural marble, for interior decoration have increasingly attracted attention, as the income level and the demand for interior decoration increases. However, since the natural marble is very expensive and too heavy, the natural marble has low economic feasibility and construction efficiency for interior decoration. Further, since natural stone materials exhibit low elasticity despite high hardness, the natural stone materials are easily broken by external impact during construction or use thereof.

Thus, in application of the natural stone to interior/exterior materials for construction, the natural stone provides several problems such as high material and construction costs, difficulty in construction, and easy damage by impact during construction or use thereof.

To solve such problems, composite tile products that combine marble and ceramic tiles have been developed. Such products solve problems relating to the heavy weight of natural stone, but still suffer from disadvantages, such as breakage and delamination of the marble upon impact.

Korean Patent Laid-open Publication No. 2006-0004385 discloses a decorative panel, which includes a natural marble sheet and a reinforcing member attached to one side of the natural marble sheet, wherein the reinforcing member comprises a foamed synthetic resin or a liquid mortar comprising cement, sand, and water. Further, Korean Patent Laid-open Publication No. 2002-0041407 discloses a composite tile, which includes a natural stone layer and a support sheet bonded to the natural stone layer by adhesives, wherein the support sheet comprises silica, cement, sand, cellulose fibers, a stabilizer, and a water-repelling agent.

In addition to the aforementioned materials, metallic materials including iron, aluminum or copper, or plastics including acryl, epoxy or polyester resins may be used as the reinforcing material. However, the reinforcing materials known in the art do not provide sufficient strength against impact due to insignificant reinforcing effect or easy separation from the natural stone layer used for interior decoration.

### TECHNICAL PROBLEM

Aspects of the present disclosure provide a natural stone composite panel and a method of fabricating the same, which has outstanding properties, such as light weight, easy handling, construction efficiency and economic feasibility, while exhibiting outstanding strength even with a very low thickness of natural stone in the panel.

### TECHNICAL SOLUTION

In accordance with an aspect of the present disclosure, a natural stone composite panel includes a natural stone sheet and a composite reinforcing layer or layers formed on one or both sides of the natural stone sheet and having at least one strengthening layer and at least one base material layer.

In accordance with another aspect of the present disclosure, a natural stone composite panel includes a natural stone sheet, a fiber-glass scrim layer under the natural stone sheet and an inorganic base material layer under the fiber-glass scrim layer.

In accordance with a further aspect of the present disclosure, a natural stone composite panel includes a natural stone sheet, a fiber-reinforced plastic layer under the natural stone sheet, a synthetic resin base material layer under the fiber-reinforced plastic layer and a fiber-reinforced plastic layer under the synthetic resin base material layer.

In accordance with yet another aspect of the present disclosure, a method of fabricating a natural stone composite panel includes preparing a composite reinforcing layer by bonding at least one strengthening layer and at least one base material layer and bonding the composite reinforcing layer or layers to one or both sides of a natural stone sheet.

In accordance with yet another aspect of the present disclosure, a method of fabricating a natural stone composite panel includes preparing a laminate by bonding a strengthening layer or layers or a base material layer or layers to one or both sides of a natural stone sheet and bonding an additional strengthening layer or layers or an additional base material layer or layers to one or both sides of the laminate.

### DESCRIPTION OF DRAWINGS

FIGS. 1 and 2 are side-sectional views of a natural stone composite panel in accordance with an exemplary embodiment of the present disclosure; and

FIG. 3 is a diagram illustrating a process of measuring bending strength of an example of a natural stone composite panel in accordance with the present disclosure.

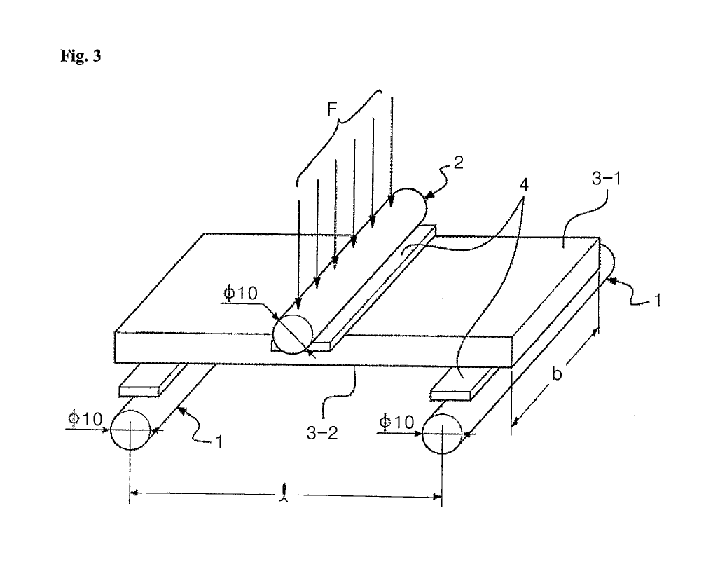

### EMBODIMENTS

A natural stone composite panel according to an embodiment of the present disclosure includes a natural stone sheet and a composite reinforcing layer or layers formed on one or both sides of the natural stone sheet and having at least one strengthening layer and at least one base material layer.

The natural stone composite panel according to the embodiment of the present disclosure will now be described in more detail.

Natural stone for the natural stone composite panel according to the embodiment is not limited to a specific one and any kind of natural stone applicable to materials for interior decoration may be used. Examples of the applicable natural stone include a variety of marbles. As described above, when natural stone is used for an interior panel, processing the natural stone into a thin layer for the panel is difficult in the related art due to low elasticity of the natural stone. However, the embodiment of the present disclosure enables processing of the natural stone into a thin layer while providing sufficient strength to the panel during construction or use of the panel.

Accordingly, the natural stone sheet may have a thickness of 0.5˜20 mm, preferably 0.5˜10 mm, and more preferably 3˜5 mm. If the thickness of the natural stone sheet is less than 0.5 mm, there is a possibility of decrease in the total strength of the panel, whereas if the thickness of the natural stone sheet exceeds 20 mm, there is a possibility of increase of weight and deterioration in construction efficiency, economic feasibility and/or ease of handling.

The composite panel according to the embodiment includes a composite reinforcing layer or layers formed on one or both sides of the natural stone sheet to reinforce the natural stone. Herein, the term “composite reinforcing layer or layers” means a layer or layers formed by stacking at least one strengthening layer and at least one base material layer on each other. Here, the number, sequence and shape of strengthening layers and base material layers stacked on each other are not specifically limited.

Herein, the term “strengthening layer” means a layer formed by a reinforcing fiber layer or fiber-reinforced plastic layer alone, a layer formed by stacking two or more reinforcing fiber layers or fiber-reinforced plastic layers, or a layer formed by a combination of these two kinds of layers. Here, when the strengthening layer is formed by the combination of these two kinds of layers, the number, sequence and shape of reinforcing fiber layers and fiber-reinforced plastic layers are not specifically limited.

Examples of the reinforcing fiber layer may include one or two kinds of glass fibers, carbon fibers, polyester fibers, polyamide fibers, polyurethane fibers, acryl fibers, polyolefin fibers, or cellulose fibers. It is desirable for the reinforcing fiber layer to comprise the glass fiber, but the present disclosure is not limited thereto. In this invention, the reinforcing fiber may be provided to the panel in the form of a woven or non-woven fabric sheet or in the form of scrim. It is desirable that the reinforcing fiber be provided in the form of scrim to the panel. Herein, the term “scrim” means a screen-shaped sheet composed of fibers which constitute the reinforcing fiber layer. As such, when the sheet in the form of scrim, for example, glass-fiber scrim, is used as the reinforcing fiber, adhesives for bonding the respective layers constituting the panel pass through the screen of the reinforcing fibers provided in the form of scrim to be integrated therewith, thereby enhancing interface adhesion between the respective layers of the panel while providing outstanding durability to the panel. According to the present disclosure, when the reinforcing fiber layer is provided in the form of scrim, the number of lattice-shaped openings per square inch in the reinforcing fiber layer may be 10˜220 mesh, but is not limited thereto.

The reinforcing fiber layer may have a thickness of 0.1˜1 mm. If the thickness of the reinforcing fiber layer is less than 0.1 mm, the reinforcing fiber layer is likely to provide an insignificant reinforcing effect, whereas if the thickness of the reinforcing fiber layer exceeds 1 mm, deterioration in ease of handling and economic feasibility of the panel can occur.

In one embodiment of the present disclosure, the strengthening layer may include the fiber-reinforced plastic layer alone or together with the aforementioned reinforcing fiber layer. As used herein, the term “fiber-reinforced plastic layer” means a reinforcing fiber contained plastic layer, which is formed by impregnating a reinforcing material such as glass fibers, carbon fibers or synthetic fibers into a synthetic resin and then curing the resultant, and exhibits improved mechanical strength and thermal resistance. Specifically, the reinforcing fiber-contained plastic layer may include synthetic resin-impregnated woven fabrics or non-woven fabrics, or synthetic resin-impregnated scrim.

According to the present disclosure, the woven fabric, non-woven fabric or scrim for the reinforcing fiber-contained plastic is not limited to a specific kind, and may comprise at least one kind of fiber selected from the group consisting of, for example, glass fibers, carbon fibers, polyester fibers, polyamide fibers, polyurethane fibers, acryl fibers, polyolefin fibers, and cellulose fibers. Further, the synthetic resin included in the fiber-reinforced plastic layer is not limited to a specific kind either and may include, for example, a urethane resin, a melamine resin, a phenol resin, an epoxy resin, a polyester resin, and a polyvinyl chloride resin.

According to the present disclosure, the fiber-reinforced plastic layer may have a thickness of 0.01˜10 mm, and preferably 0.012 mm. If the thickness of the fiber-reinforced plastic layer is less than 0.01 mm, there is a possibility of deterioration in reinforcing effect, whereas if the thickness of the fiber-reinforced plastic layer exceeds 10 mm, there is a possibility of deterioration in handling efficiency of the panel.

According to the present disclosure, the composite reinforcing layer further includes a base material layer along with the strengthening layer. A combination of the strengthening layer and the base material layer may provide significantly improved effects in terms of impact absorption and anti-scattering of natural stone upon impact to the natural stone sheet.

The base material layer may be formed of one selected from the group consisting of an inorganic base material, a synthetic resin base material, a wooden material, and a combination thereof. The inorganic base material may be at least one selected from the group consisting of a cement board, a concrete board, a calcium silicate board, a magnesium board, a vermiculite board, a ceramic board, and a magnetic board, but is not limited thereto. The synthetic resin base material may be a foamed or non-foamed base material of at least one resin selected from the group consisting of polyvinyl chloride, polyethylene, polypropylene, polyester, polyamide, polystyrene, polyurethane, and polycarbonate, but is not limited thereto. The wooden material may be at least one selected from the group consisting of wooden floor sheets, sawdust, medium density fiberboard (MDF), high density fiberboard (HDF), veneer boards, and plywood, but is not limited thereto.

The base material layer included in the composite reinforcing layer has a thickness of 1˜35 mm, and preferably 1˜20 mm. If the thickness of the base material layer is less than 1 mm, the base material layer provides an insignificant reinforcing effect, whereas if the thickness of the base material layer exceeds 35 mm, the weight of the panel increases and deterioration in ease of handling and economic feasibility of the panel can occur.

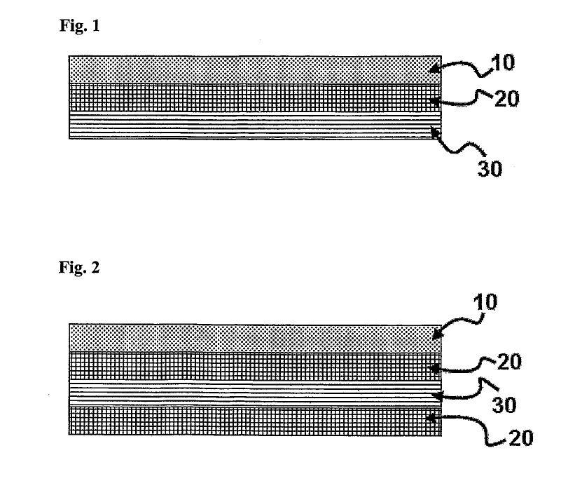

According to the present disclosure, the composite panel may have a variety of lamination structures and is not limited to a specific one. In one embodiment, the composite panel may be stacked in sequence of a natural stone sheet 10, strengthening layer 20 and base material layer 30, as shown in FIG. 1.

When the composite panel has the structure as described above, the strengthening layer 20 may be a glass fiber scrim layer. In this manner, when the strengthening layer 20 is formed of the glass fiber scrim layer, the adhesives used for bonding the base material layer to the natural stone pass through the screen structure of the glass fiber scrim to be integrated therewith, thereby enhancing the interface adhesion between the respective layers of the composite panel while providing outstanding durability to the overall panel.

Further, when the composite panel has the structure as described above, the base material layer 30 may be a certain inorganic base material as described above. In this manner, when the reinforcing layer is formed by a combination of the glass fiber scrim and the inorganic base material, it is possible to provide outstanding strength, dimensional stability, construction efficiency, and durability to the composite panel of the present disclosure.

In another embodiment, the composite panel may be stacked in sequence of a natural stone sheet 10, a strengthening layer 20, a base material layer 30 under the strengthening layer 20, and another strengthening layer 20 under the base material layer 30, as shown in FIG. 2.

When the composite panel has the structure as described above, the strengthening layer 20 may be a fiber-reinforced plastic layer and the base material layer 30 may be a synthetic resin base material. In this manner, the composite panel uses a composite reinforcing layer in which both sides of the synthetic resin base material are symmetrically reinforced by the fiber-reinforced plastic layers, so that the panel may have outstanding properties. In particular, the fiber-reinforced plastic layer provides excellent interface adhesion between the respective layers of the panel by supplementing the synthetic resin base material, which exhibits relatively low adhesion with respect to the natural stone, thereby improving durability of the panel. Further, the fiber-reinforced plastic layers are symmetrically provided to both sides of the base material, thereby providing outstanding properties to the panel in terms of strength, handling efficiency, and construction efficiency.

According to the present disclosure, a method for fabricating the natural stone composite panel described above is not limited to a specific one. For example, the composite panel of the present disclosure may be fabricated by preparing a composite reinforcing layer and bonding the composite reinforcing layer or layers to one or both sides of a natural stone sheet. Alternatively, the composite panel of the present disclosure may be fabricated by sequentially stacking a strengthening layer or layers and a base material layer or layers on one or both sides of a natural stone sheet according to a desired lamination structure such that a composite reinforcing layer is finally included in the panel, instead of preparing the composite reinforcing layer in the first stage.

In other words, according to an aspect of the present disclosure, a method of fabricating a natural stone composite panel includes preparing a composite reinforcing layer by bonding at least one strengthening layer and at least one base material layer, and bonding the composite reinforcing layer or layers to one or both sides of a natural stone sheet.

According to another aspect of the present disclosure, a method of fabricating a natural stone composite panel includes preparing a laminate by bonding a strengthening layer or layers or a base material layer or layers to one or both sides of a natural stone sheet, and bonding an additional strengthening layer layers or an additional base material layer or layers to one or both sides of the laminate.

According to the present disclosure, a method of bonding the reinforcing layer, base material layer and natural stone sheet to one another is not limited to a specific one. For example, any general adhesive, such as epoxy adhesive, acrylic adhesive or urethane adhesive, may be used.

In the method of fabricating the composite panel according to the present disclosure, the number and bonding sequence of composite reinforcing layers or the number and bonding sequence of strengthening layers and base material layers sequentially stacked on one or both sides of the natural stone sheet are determined depending on a desired lamination structure of the panel. Here, although the composite reinforcing layer(s), strengthening layer(s) or base material layer(s) may be formed on one or both sides of the natural stone sheet, it is desirable in terms of manufacturing efficiency that the composite reinforcing layers, strengthening layers or base material layers be formed on both sides of the natural stone sheet. In other words, two composite panels may be fabricated through a single process of cutting the natural stone sheet along the center thereof in the horizontal direction after forming the composite reinforcing layers on both sides of the natural stone sheet, thereby reducing time and cost for fabrication of the composite panel. In one embodiment of the present disclosure, a plurality of composite panels may be fabricated using a single piece of natural raw stone by repeating a series of operations of attaching a composite reinforcing layer to either side of a natural stone sheet, cutting the natural stone sheet, and attaching an additional composite reinforcing layer to a cut surface of the natural sheet.

In another embodiment of the present disclosure, the method may further include cutting the composite panel according to a desired use after fabricating the composite panel. Cutting the composite panel may be performed using a proper device, such as a circular saw, a belt-type saw, a water jet cutter, and the like. For example, for a composite panel having composite reinforcing layers on both sides of a natural stone sheet, the composite panel is divided into two composite panels by horizontally cutting the natural stone sheet along the center thereof, and each of the divided composite panels is subjected to a finishing operation by grinding a cut surface of the composite panel to adjust the thickness of the composite panel while providing a glossy finish to the cut surface. During this process, the composite panel may be cut into a suitable size depending on a desired use of the panel by cutting a lateral side of the panel.

### EXAMPLES

Next, examples of the present disclosure will be described in detail along with comparative examples. However, it should be understood that the present invention is not limited to the following examples.

### Example 1

After applying epoxy adhesives for stone to either side of a 600 mm×2400 mm×20 mm (width×length×thickness) natural marble sheet, a fiber-reinforced plastic layer (thickness: 1 mm) was bonded to either side of the natural marble sheet and then sufficiently dried for 24 hours at room temperature. Here, the fiber-reinforced plastic layer was formed by impregnating an epoxy resin in a weight ratio of 1:1 into glass fiber woven fabrics, which in turn were cured at a pressure of 30 kgf/cm² and a temperature of 160° C. for 1 hour. Then, with the epoxy adhesives applied to one side of the plastic layer, a polyvinyl chloride sheet (thickness: 3 mm) was bonded thereto and then sufficiently dried again. Next, the resultant laminate was divided into, two laminates by passing the laminate through a stationary circular saw to cut the natural marble sheet along the center thereof. Then, the surface of the divided laminate was ground using a grinder until the natural stone sheet had a thickness of about 4 mm. Then, the divided laminate was cut into a desired size using a diamond cutter, followed by polishing to provide a glossy finish to the surface of the divided laminate, thereby fabricating a natural-marble composite panel.

### Example 2

After applying epoxy adhesives for stone to both sides of a 600 mm×600 mm×20 mm (width×length×thickness) size natural marble sheet, 0.2 mm thick glass fiber scrim sheets each having 60 lattice-shaped openings per square inch and 9 mm thick ceramic base material layers were sequentially stacked on both sides of the marble sheet. Then, the resultant laminate was sufficiently dried at room temperature for 24 hours and then divided into two laminates by passing the laminate through a stationary circular saw to cut the natural stone sheet (marble) along the center thereof. Then, the surface of the divided laminate was ground using a grinder until the natural stone sheet had a thickness of about 3 mm. Then, the divided laminate was cut into a desired size using a diamond cutter, followed by polishing to provide a glossy finish to the surface of the divided laminate, thereby fabricating a natural-marble composite panel.

### Example 3

Using the method of Example 1, a natural stone composite panel including fiber-reinforced plastic layers on both sides of a PVC base material was fabricated by bonding a polyvinyl chloride sheet (thickness: 3 mm) to one fiber-reinforced plastic layer and bonding the other fiber-reinforced plastic layer to one side of the polyvinyl chloride sheet.

### Comparative Example 1

A composite panel of Comparative Example 1 was prepared by method of Example 1 except that an additional polyvinyl chloride sheet was not bonded after bonding the fiber-reinforced plastic layer.

Test 1: Measurement of Impact Strength

For each of the composite panels of Examples 1 and 2, a typical 20 mm thick marble sheet (Conventional Example 1), and a general marble tile with 3 mm thick piece of marble and a 9 mm thick tile attached thereto (Conventional Example 2), impact strength was measured according to KS F 2221. Specifically, each specimen was stacked atop a thick layer of sand as provided in KS F 5100 and a 500 g eggplant-shaped weight was then dropped thereto from a height of 100 cm for a specimen of Example 1 and from a height of 50 cm for specimens of Conventional Examples 1 and 2. It was then observed whether the specimen was cracked or not. Results are shown in Table 1.

TABLE 1

| | | | Conventional | Conventional |
|---|---|---|---|---|
| | Example 1 | Example 2 | Example 1 | Example 2 |
| Result | Not broken | Not broken | Broken | Broken |

As shown in Table 1, the specimens of Conventional Examples 1 and 2 corresponding to conventional natural stone panels were completely broken upon impact of the weight dropped from a height of 50 cm, whereas the specimens of Examples 1 and 2 were not broken upon impact of the weight dropped from a height of 100 cm. Based upon these results, it can be seen that the specimens of Examples 1 and 2 have significantly improved impact strength.

Test 2: Measurement of Bending Strength

For each of the composite panels of Examples 1 and 2 and Comparative Example 1, bending strength was measured according to KS F 1001 and KS L 1001. Specifically, with each test panel (3-1, 3-2) placed on metal support rods 1 having a diameter of 10 mm and separated a constant distance from each other, the bending strength was measured by placing a compression rod 2 having the same shape as that of the metal support rod 1 on a middle position of the panel between the metal support rods 1 to apply load to the panel. Results are shown in Table 2.

TABLE 2

| | | | Comparative |
|---|---|---|---|
| | Example 1 | Example 2 | Example 1 |
| Bending strength | 320 | 281 | 39 |
| (N/cm) | | | |

As can be seen from Table 2, the composite panel of Example 1 using the composite reinforcing layer including both a fiber-reinforced plastic layer and a base material layer had 8 times higher strength than the composite panel using the fiber-reinforced plastic layer alone. Further, the composite panel of Example 2 using the composite reinforcing layer including both a reinforcing fiber layer and a base material layer had about 7 times higher strength than Comparative Example 1.

### INDUSTRIAL APPLICABILITY

In one embodiment of the present disclosure, a natural stone sheet is reinforced by a composite reinforcing layer, which includes a strengthening layer and a base material layer, so that the panel exhibits outstanding strength even with a very low thickness of the natural stone sheet in the panel. Accordingly, the natural stone composite panel according to the embodiment of the present disclosure has outstanding properties, such as light weight, easy handling, construction efficiency and economic feasibility, while maintaining outstanding resistance to shock.

1. A natural stone composite panel comprising:
a natural stone sheet comprising a first surface; and
a composite reinforcing layer over the first surface of the natural stone sheet, the composite reinforcing layer comprising at least one strengthening layer and at least one base material layer.

2. The composite panel of claim 1, wherein the natural stone sheet has a thickness of 0.5 mm to 20 mm.

3. The composite panel of claim 1, wherein the at least one strengthening layer comprises a reinforcing fiber layer or a fiber-reinforced plastic layer.

4. The composite panel of claim 3, wherein the reinforcing fiber layer comprises at least one of woven fabrics, non-woven fabrics and scrims, which comprise at least one form of fibers selected from the group consisting of glass fibers, carbon fibers, polyester fibers, polyamide fibers, polyurethane fibers, acryl fibers, polyolefin fibers, and cellulose fibers.

5. The composite panel of claim 3, wherein the reinforcing fiber layer has a thickness of 0.1 mm to 1 mm.

6. The composite panel of claim 3, wherein the fiber-reinforced plastic layer comprises at least one of a synthetic resin-impregnated woven fabric, synthetic resin-impregnated non-woven fabric, and a synthetic resin-impregnated scrim.

7. The composite panel of claim 6, wherein the at least one of the synthetic resin-impregnated woven fabric, synthetic resin-impregnated non-woven fabric and synthetic resin-impregnated scrim comprise at least one form of fibers selected from the group consisting of glass fibers, carbon fibers, polyester fibers, polyamide fibers, polyurethane fibers, acryl fibers, polyolefin fibers, and cellulose fibers.

8. The composite panel of claim 6, wherein the synthetic resin comprises at least one selected from the group consisting of a urethane resin, a melamine resin, a phenol resin, an epoxy resin, a polyester resin, and a polyvinyl chloride resin.

9. The composite panel of claim 3, wherein the fiber-reinforced plastic layer has a thickness of 0.01 mm to 10 mm.

10. The composite panel of claim 1, wherein the base material layer comprises at least one of an inorganic material, a synthetic resin material, and a wooden material.

11. The composite panel of claim 10, wherein the inorganic material comprises at least one selected from the group consisting of a cement board, a concrete board, a calcium silicate board, a magnesium board, a vermiculite board, a ceramic board and a magnetic board,
wherein the synthetic resin material comprises a foamed or non-foamed material of at least one selected from the group consisting of polyvinyl chloride, polyethylene, polypropylene, polyester, polyamide, polystyrene, polyurethane and polycarbonate, and
wherein the wooden material comprises at least one selected from the group consisting of wooden floor sheets, sawdust, medium density fiberboard (MDF), high density fiberboard (HDF), veneer boards, and plywood.

12. The composite panel of claim 1, wherein the base material layer has a thickness of 1 mm to 35 mm.

13. A method of fabricating the natural stone composite panel of claim 1, the method comprising:
providing the composite reinforcing layer, in which the at least one strengthening layer and the at least one base material layer are bonded together; and
bonding the composite reinforcing layer onto the first surface of the natural stone sheet.

14. A method of fabricating the natural stone composite panel of claim 1, the method comprising:
providing the natural stone sheet comprising the first surface and a second surface facing away from the first surface;
bonding, to the first surface, the strengthening layer or the base material layer; and
bonding, to the second surface, another strengthening layer or another base material layer.

15. A natural stone composite panel comprising:
a natural stone sheet;
a fiber-glass scrim layer; and
an inorganic base material layer, wherein the fiber-glass scrim layer is interposed between the natural stone sheet and the inorganic base material layer.

16. A natural stone composite panel comprising:
a natural stone sheet;
a first fiber-reinforced plastic layer under the natural stone sheet;
a synthetic resin base material layer; and
a second fiber-reinforced plastic layer, wherein the synthetic resin base material layer is interposed between the first and second fiber-reinforced plastic layer.

17. The composite panel of claim 16, wherein the first fiber-reinforced plastic layer comprises at least one of a synthetic resin-impregnated woven fabric, synthetic resin-impregnated non-woven fabric, and a synthetic resin-impregnated scrim,
wherein the second fiber-reinforced plastic layer comprises at least one of a synthetic resin-impregnated woven fabric, synthetic resin-impregnated non-woven fabric, and a synthetic resin-impregnated scrim.

18. The composite panel of claim 1, wherein the natural stone sheet comprising a second surface, wherein the composite panel further comprises another composite reinforcing layer over the second surface of the natural stone sheet, wherein the other composite reinforcing layer comprises at least one strengthening layer and at least one base material layer.

19. The composite panel of claim 15, wherein the inorganic material comprises at least one selected from the group consisting of a cement board, a concrete board, a calcium silicate board, a magnesium board, a vermiculite board, a ceramic board and a magnetic board.

20. The composite panel of claim 15, wherein the fiber-glass scrim layer comprises at least one form of fibers selected from the group consisting of glass fibers, carbon fibers, polyester fibers, polyamide fibers, polyurethane fibers, acryl fibers, polyolefin fibers, and cellulose fibers.
